(19) United States
(12) Patent Application Publication
(10) Pub. No.: US 2018/0078992 A1
(43) Pub. Date: Mar. 22, 2018

(54) Secure Enclosure System and Associated Methods

(71) Applicant: Wal-Mart Stores, Inc., Bentonville, AR (US)

(72) Inventors: Donald R. High, Noel, MO (US); Bruce W. Wilkinson, Rogers, AR (US); David Winkle, Bella Vista, AR (US); Matthew Allen Jones, Bentonville, AR (US); Aaron James Vasgaard, Fayetteville, AR (US); Nicholaus Adam Jones, Fayetteville, AR (US); Robert James Taylor, Rogers, AR (US); Todd Davenport Mattingly, Bentonville, AR (US)

(21) Appl. No.: 15/672,772

(22) Filed: Aug. 9, 2017

Related U.S. Application Data
(60) Provisional application No. 62/396,607, filed on Sep. 19, 2016.

(51) Int. Cl. B21D 51/44; B23Q 41/02; B26D 5/22

(52) U.S. Cl. CPC B21D 51/44; B29C 2043/046; B26D 5/22; B23Q 41/02

(57) ABSTRACT

An example secure enclosure system and associated methods are described. The example enclosure system includes a housing, a shelf disposed within the housing, an array of sensors arranged within the housing, and an interface operatively coupled to the array of sensors. The shelf includes a supporting surface configured to support physical objects. The array of sensors is configured to detect characteristics of the each physical object supported by the supporting surface of the shelf. The interface is configured to transmit the detected characteristics from the array of sensors to a central computing system. The central computing system is configured to determine an identity of each physical object based on the detected characteristics.

### CROSS-REFERENCE TO RELATED APPLICATIONS

This application claims the benefit of co-pending, commonly assigned U.S. Provisional Patent Application No. 62/396,607, which was filed on Sep. 19, 2016. The entire content of the foregoing provisional patent application is incorporated herein by reference.

### BACKGROUND

The amount of merchandise purchased from online retailers has continuously increased since the availability of the internet, and with development of smart devices. Delivery of the purchased merchandise is generally made directly to the customer if the customer is available to accept the delivery. If the customer is unavailable to accept delivery of the purchased merchandise, delivery can be made to an enclosure (e.g., a locker, or the like) from which the customer can obtain the delivered merchandise at a future point in time.

### SUMMARY

Exemplary embodiments of the present disclosure provide a secure enclosure system that notifies the customer of the identity of a physical object delivered to the enclosure. In particular, the enclosure system includes a housing with a shelf disposed therein, and an array of sensors arranged within the housing for detecting characteristics of the physical object supported on the shelf. Based on the detected characteristics of the physical object, the physical object enclosure system determines the identity of the physical object such that the customer can be notified of the physical object delivered to the enclosure.

In accordance with embodiments of the present disclosure, an exemplary enclosure system is provided. The enclosure system includes a housing, a shelf disposed within the housing, and an array of sensors arranged within the housing. The housing includes a rear wall, side walls, a top wall, and a bottom wall. The housing includes a door forming a front wall. The door can be configured to move between an open position in which an interior of the housing is accessible and a closed position in which the interior of the housing is inaccessible. The door can be configured to be selectively locked in the closed position.

The shelf includes a supporting surface configured to support merchandise. The array of sensors can be configured to detect one or more characteristics of the physical object supported by the supporting surface of the shelf. The enclosure system includes an interface operatively coupled to the array of sensors and configured to transmit the detected characteristics from the array of sensors to a central computing system. The central computing system can be configured to determine the identity of the physical object based on the detected characteristics.

The array of sensors can be arranged on at least one of the side walls, the top wall, the bottom wall, or an inner surface of the door of the housing. The array of sensors can be configured to measure at least one of weight, pressure, temperature, or moisture within the housing. The array of sensors can include one or more optical sensors configured to analyze dimensions of the merchandise. The array of sensors can be configured to detect and recognize text displayed on the merchandise.

In some embodiments, the array of sensors can include a piezoelectric grid. Each component of the piezoelectric grid can be configured to detect characteristics of the merchandise. In some embodiments, the array of sensors can include one or more barcode scanners configured to detect a barcode displayed on the merchandise. In some embodiments, the array of sensors can define a three-dimensional array of sensors arranged within the housing. The central computing system can be configured to transmit the identity of the physical object to a customer awaiting arrival of the merchandise.

In accordance with embodiments of the present disclosure, an exemplary method of monitoring an interior of a secure enclosure is provided. The method includes providing an enclosure system as described herein. The method includes supporting the physical object on the supporting surface of the shelf. The method includes detecting characteristics of the physical object supported by the supporting surface of the shelf with the array of sensors. The method includes transmitting the detected characteristics from the array of sensors to the central computing system with the interface. The method includes determining an identity of the physical object based on the detected characteristics with the central computer system.

The array of sensors can be arranged on at least one of the side walls, the top wall, the bottom wall, or an inner surface of the door of the housing. The method includes measuring at least one of weight, pressure, temperature, or moisture within the housing with the array of sensors. In some embodiments, the array of sensors can include one or more optical sensors. In such embodiments, the method can include analyzing dimensions of the physical object with the one or more optical sensors. The method can include detecting and recognizing text displayed on the physical object with the array of sensors.

In some embodiments, the array of sensors can include a piezoelectric grid. Each component of the piezoelectric grid can be configured to detect characteristics of the physical object. In some embodiments, the array of sensors can include one or more barcode scanners. In such embodiments, the method can include detecting a barcode displayed on the physical object with the one or more barcode scanners. The method can include transmitting the identity of the physical object to a customer awaiting arrival of the physical object with the central computing system.

In accordance with embodiments of the present disclosure, an exemplary non-transitory computer-readable medium storing instructions for monitoring physical object positioned on a shelf of an enclosure that are executable by a processing device is provided. Execution of the instructions by the processing device can cause the processing device to detect characteristics of the physical object supported by the supporting surface of the shelf with the array of sensors. Execution of the instructions by the processing device can cause the processing device to transmit the detected characteristics from the array of sensors to a central computing system with an interface. Execution of the instructions by the processing device can cause the processing device to determine an identity of the physical object based on the detected characteristics with the central computing system.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed secure enclosure system and associated methods, reference is made to the accompanying figures, wherein:

FIG. 1 is a block diagram of an exemplary secure enclosure system of the present disclosure;

FIG. 2 is a diagrammatic perspective view of an exemplary housing of the present disclosure;

FIG. 3 is a diagrammatic top view of an exemplary shelf of a housing of the present disclosure;

FIG. 4 is a block diagram of a computing device in accordance with exemplary embodiments of the present disclosure;

FIG. 5 is a block diagram of an exemplary secure enclosure system environment in accordance with embodiments of the present disclosure; and

FIG. 6 is a flowchart illustrating a process implemented by an exemplary secure enclosure system in accordance with embodiments of the present disclosure.

### DETAILED DESCRIPTION

It should be understood that the relative terminology used herein, such as “front”, “rear”, “left”, “top”, “bottom”, “vertical”, “horizontal”, “up” and “down” is solely for the purposes of clarity and designation and is not intended to limit embodiments to a particular position and/or orientation. Accordingly, such relative terminology should not be construed to limit the scope of the present disclosure. In addition, it should be understood that the scope of the present disclosure is not limited to embodiments having specific dimensions. Thus, any dimensions provided herein are merely for an exemplary purpose and are not intended to limit the invention to embodiments having particular dimensions.

Exemplary embodiments of the present disclosure provide a secure enclosure system that notifies the user of delivery of one or more physical objects to the enclosure, as well as the identity of the one or more physical objects delivered to the enclosure. In particular, the secure enclosure system includes a housing with a shelf disposed therein, and an array of sensors arranged within the housing for detecting characteristics of the one or more physical objects supported on the shelf. Based on the detected characteristics of the one or more physical objects, embodiments of the enclosure system can determine the identity of the one or more physical objects such that the customer can be notified of the delivered one or more physical objects to the enclosure.

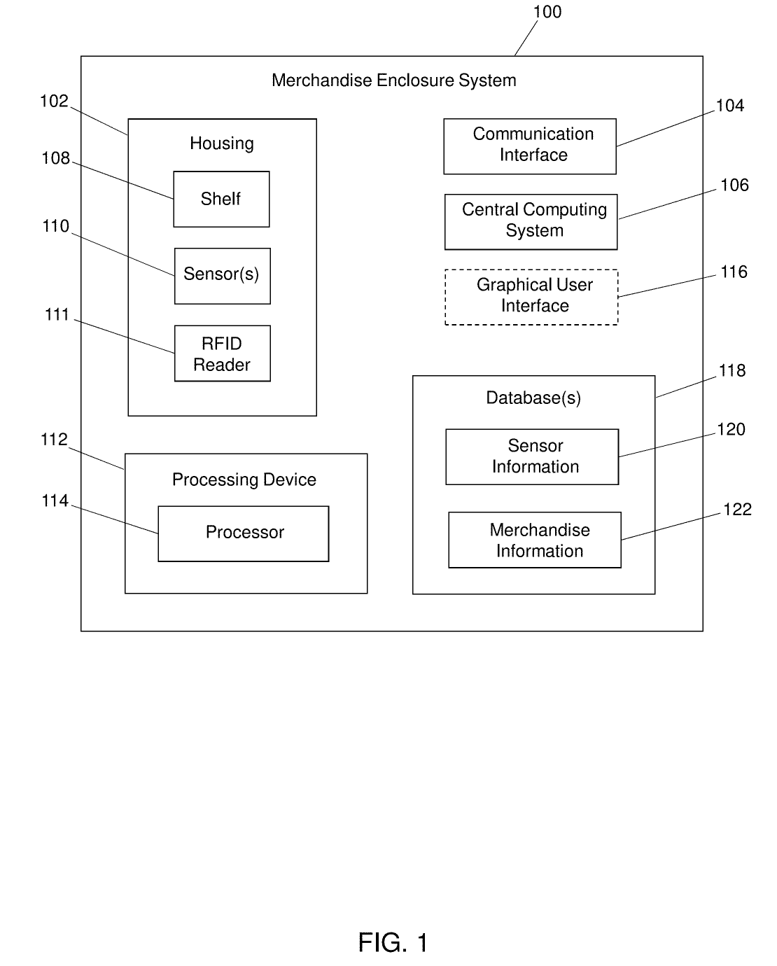

FIG. 1 is a block diagram of an exemplary secure enclosure system 100 (hereinafter “system 100”) of the present disclosure. The system 100 generally includes a housing 102, a communication interface 104 (e.g., an interface), and a central computing system 106. The housing 102 generally forms an enclosure configured and dimensioned to receive one or more physical objects (e.g., in the form of packages or merchandise). The housing 102 can include a rear wall, side walls, a top wall, a bottom wall, and a door forming a front wall. The door can be configured to move between an open position in which an interior of the housing 102 is accessible, and a closed position in which the interior of the housing 102 is inaccessible. The housing 102 can include a lock to selectively lock the door in the closed position. In some embodiments, the housing 102 can define a substantially cubic or rectangular configuration. In some embodiments, the housing 102 can define alternative configurations, e.g., cylindrical, trapezoidal, spherical, and/or any other suitable configuration.

The housing 102 can include one or more shelves 108 disposed therein. Each of the shelves 108 includes a supporting surface configured and dimensioned to receive one or more packages or merchandise thereon. For example, during delivery the door of the housing 102 can be unlocked and opened, the packages or merchandise can be positioned on the supporting surface of the shelves 108, and the door can be closed and locked. The housing 102 includes an array of sensors 110 arranged within the housing 102. The sensors 110 can be configured to detect characteristics (e.g., serial number, barcode number, universal product code (UPC) number, stock keeping unit (SKU) number, weight, dimensions, configuration, text on the packages or merchandise, images on the packages or merchandise, radio frequency identification (RFID) tags, combinations thereof, or the like) of the packages or merchandise supported by the supporting surfaces of the shelves 108. The sensors 110 can also be configured to detect characteristics or conditions within the housing 102 as well as the characteristics of the physical object placed within the housing 102 (e.g., temperature, humidity, moisture or liquid presence, size of physical object, color of physical object, smell of physical object (by using a spectrometer), reflectivity of the physical object (by using a RFID reader 111 and detecting then reflected signal), absorption of a radio frequency signal by the physical object (by using the RFID reader 111), combinations thereof, or the like).

In some embodiments, the sensors 110 can be disposed on only the supporting surfaces of the shelves 108. In some embodiments, the sensors 110 can be disposed on, e.g., the support surfaces of the shelves 108, a bottom surface or underside of the shelves 108, the rear wall of the housing 102, one or more of the side walls of the housing 102, the top wall of the housing 102, the bottom wall of the housing 102, the inside surface of the door of the housing 102, combinations thereof, or the like. In some embodiments, the sensors 110 can be in the form of, e.g., an optical sensor, a piezoelectric sensor, a radio frequency receiver/antenna (e.g., an RFID reader 111), a pressure sensor, a weight sensor, a temperature sensor, a moisture or liquid sensor, a humidity sensor, a an image capturing device (e.g., video and/or still image cameras), combinations thereof, or the like. In some embodiments, an array of the sensors 110 can be in the form of a grid covering a portion of or the entire surface of a structure within the housing 102. In some embodiments, an array of the sensors 110 can be in the form of a three-dimensional array. In some embodiments, the sensors 110 can be stationary or immobile sensors 110. In some embodiments, at least some of the sensors 110 can move (e.g., rotate) or scan a surrounding area (e.g., substantially 360°).

The communication interface 104 can be operatively coupled to the array of sensors 110 and configured to electronically transmit via wireless and/or wired means the detected characteristics from the array of sensors 110 to the central computing system 106. In some embodiments, the communication interface 104 and/or the central computing system 106 can be disposed within the housing 102. In some embodiments, the central computing system 106 can include a processing device 112 with a processor 114 disposed therein. In some embodiments, the processing device 112 and the processor 114 can be separate components from the central computing system 106. Using the processing device 112, the central computing system 106 analyzes the input detected characteristics from the sensors 110 and determines the identity of the physical objects, e.g., packages or merchandise, placed within the housing 102. The central computing system 106 can electronically transmit information regarding the packages or merchandise delivered to the housing 102 to a customer awaiting arrival of the packages or merchandise via a graphical user interface (GUI) 116. For example, the GUI 116 can be on a personal computer or a smart device, and the notice to the customer can be in the form of an alert indicating the time of delivery and/or identity of the packages or merchandise.

The system 100 includes one or more databases 118 configured to electronically store sensor information 120 and merchandise information 122. The sensor information 120 can include any data corresponding to the characteristics detected by the sensors 110, such as characteristics of conditions within the housing 102 and characteristics of the physical objects, e.g., packages or merchandise, delivered to the housing 102. In some embodiments, the sensor information 120 can include information regarding each of the sensors 110, such as the type of sensor 110 and the location of the sensor 110 within the housing 102.

The merchandise information 122 can include any data corresponding to information deduced about the package or merchandise delivered to the housing 102 based on the sensor information 120 (e.g., the identity of the package or merchandise, the time of delivery, or the like). In some embodiments, when multiple items are delivered in a single package, the merchandise information 122 can correlate the deduced information from the detected characteristics with order information of the customer to identify each of the items contained within the delivered package. In some embodiments, the identified merchandise can be correlated with order information of the customer to generate an alert to the customer that a specific order has been completed and/or to verify that the identity of the merchandise deposited in the enclosure correspond a merchandise ordered by the customer.

For example, the merchandise information 122 (and/or the sensed information 120) can be compared to stored characteristics of items that the customer ordered, and the system 100 can determine whether the merchandise information 122 (and/or the sensed information 120) matches one or more of the stored characteristics of the ordered items. If a match is found, the system 100 can generate an alert indicating that a specific order has been completed. If a match is not found (e.g., the system 100 determines that deposited merchandise does not correspond to merchandise ordered by the customer, such as when merchandise is incorrectly deposited into the wrong enclosure), the system 100 can generate an alert indicating that unknown merchandise has been delivered. In some embodiments, if a physical object is incorrectly deposited into an enclosure of one customer, the system 100 can notify the central computing system 106 via an alert requesting a comparison of the deposited physical object to the orders placed by the customer. Based on the comparison, if the central computing system 106 determines that the physical object does not match any of the orders placed by the customer, the central computing system 106 can transmit a request to a delivery associate to retrieve the incorrectly deposited physical object from the enclosure (e.g., with permission from the customer). In some embodiments, based on the comparison of the deposited physical object to the orders placed by the customer, the system 100 can reorder the incorrectly deposited physical object for delivery to the proper customer.

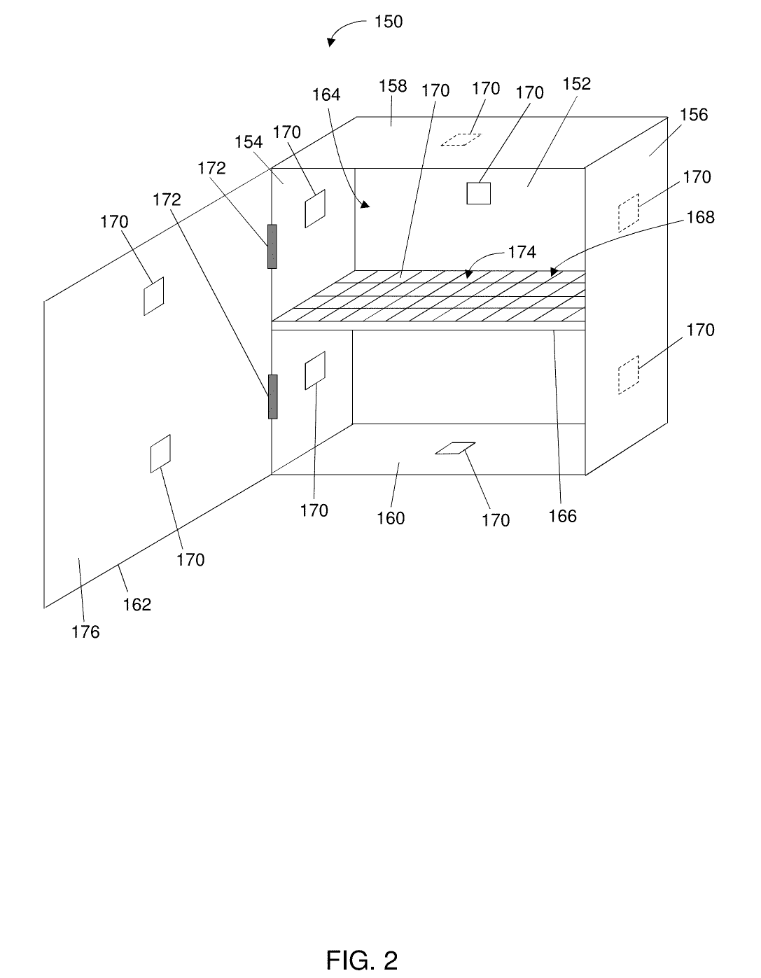

FIG. 2 is a diagrammatic perspective view of an exemplary enclosure or housing 150 of the present disclosure. The housing 150 includes a rear wall 152, side walls 154, 156, a top wall 158, a bottom wall 160, and a door 162 forming the front wall. In some embodiments, the door 162 can be connected to the side wall 154 via one or more hinges 172 such that the door 162 can be moved between an open position (shown in FIG. 2) and a closed position. The housing 150 forms an enclosure or inner chamber 164 configured and dimensioned to receive one or more delivered physical objects, e.g., packages or merchandise. The housing 150 includes one or more shelves 166 including a supporting surface 168 configured and dimensioned to receive the delivered merchandise. Although FIG. 2 shows a single shelf 166, it should be understood that multiple shelves 166 can be included in the housing 150. In addition, it should be understood that the bottom wall 160 of the housing 150 can also serve as a supporting surface 168 for merchandise.

The housing 150 includes a plurality of sensors 170 disposed therein for detecting characteristics associated with the housing 150 and/or merchandise deposited therein. In some embodiments, the sensors 170 can form an array 174 of sensors 170, such as the array 174 shown on the supporting surface 168. In some embodiments, the array 174 of sensors 170 can be disposed on other surfaces or walls within the housing 150. The array 174 of sensors can be a one-dimensional array, a two-dimensional array, and/or a three-dimensional array. In some embodiments, the array 174 of sensors 170 can cover the entire supporting surface 168. In some embodiments, the array 174 of sensors 170 can cover only a portion of the supporting surface 168. In some embodiments, the array 174 can include sensors 170 spaced relative to each other. In some embodiments, individual sensors 170 can be disposed on different surfaces or walls within the housing 150. In some embodiments, one or more sensors 170 can be disposed on an inner surface 176 of the door 162. Each sensor 170 can be configured to detect a single characteristic of the housing 150 and/or merchandise deposited therein, or one or more of the sensors 170 can be configured to detect multiple characteristics of the housing 150 and/or merchandise deposited therein. In some embodiments, the housing 150 can include a visual display and/or audio alarm for alerting a customer of delivery of merchandise to the housing 150.

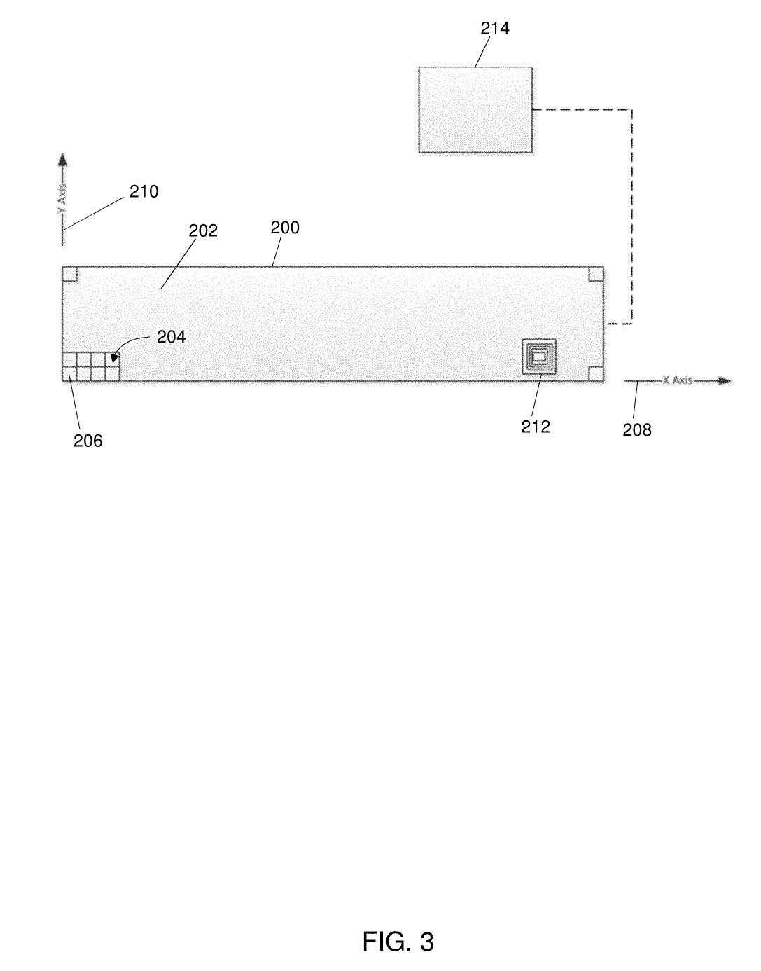

FIG. 3 is a diagrammatic top view of an exemplary shelf 200 of a housing of the present disclosure. The shelf 200 includes a supporting surface 202 with an array 204 of sensors 206. Although shown as covering only a portion of the supporting surface 202, the array 204 of sensors 206 can cover the entire supporting surface 202. The array 204 and the supporting surface 202 can define a plane extending across an x-axis 208 and y-axis 210. Each sensor 206 can be configured to individually detect characteristics of the housing and/or the merchandise disposed on the supporting surface 202, and the detected characteristics for each sensor 206 can be a function of the x-axis 208 and y-axis 210.

For example, merchandise positioned on the supporting surface 202 can extend across multiple sensors 206, with each sensor 206 having an x-axis 208 and y-axis 210 coordinate. Based on pressure sensed by each sensor 206 from the weight of the merchandise, a determination or estimation can be made regarding the dimensions of the merchandise (e.g., based on the number of sensors 206 detecting pressure from the merchandise) and the overall weight of the merchandise. The detected dimensions and/or weight can be used to determine the identity of the merchandise delivered to the housing.

As a further example, temperature sensed by each sensor 206 can determine whether a temperature increase has occurred after delivery of the package (e.g., if the package contains edible, heated food), indicating a time sensitive item has been delivered. In some embodiments, the temperature sensed by each sensor 206 can be used to determine whether an over or under temperature exposure is occurring within the housing (e.g., for perishable items). With perishable items, the system 100 can initiate a timer to notify the customer as to when the merchandise should be removed from the housing. In some embodiments, the change in temperature within the sensor 206 after the physical object has been deposited can be used to determine the thermal characteristics of the physical object. For example, if the temperature within the enclosure decreases after the physical object has been deposited, the system 100 can determine that the physical object includes a cooler with cooling elements for maintaining a perishable item under desired conditions. As a further example, if the temperature within the enclosure rises after the physical object has been deposited, the system 100 can determine that the physical object is hot. In some embodiments, one or more of the sensors 206 can detect moisture or liquid on the supporting surface 202 if the merchandise is leaking, indicating that immediate attention is needed. As a further example, the sensors 206 can be used to determine the amount of merchandise on the shelf 200.

As a further example, a sensor 206 (e.g., via optical sensors and/or image capturing devices) disposed within the housing can scan the merchandise to determine the serial number or text on the merchandise, thereby identifying the identity of the merchandise. The sensors 206 can function individually or as a group to assist in identifying the identity of the merchandise. For example, if the barcode on the merchandise is obscured, the remaining sensors 206 can be used to detect alternative characteristics of the merchandise to determine the identity of the merchandise, such as the size of the merchandise, text and/or patterns on the outside of the merchandise, the dimensions of the merchandise, the weight of the merchandise, combinations thereof, or the like. Although the merchandise can potentially be identified by a single detected characteristic, a higher number of detected characteristics can ensure the proper identification of the merchandise. For example, while a package may have a barcode that can be read by one of the sensors in the enclosure, the package may have received an incorrect barcode that does not properly identify the package. By using several sensors to detect various characteristics about the package and validating those characteristics against stored characteristics associated with packages associated with the barcode, exemplary embodiments of the system can accurately identify a package despite the package having an incorrect barcode.

In some embodiments, the housing can include a radio frequency tag 212 configured to detect radio frequency signals associated with the merchandise. In some embodiments, sensors 206 can transmit the detected characteristics of the enclosure and/or the physical object to the radio frequency tag 212, and the RFID reader 111 can be used to read the radio frequency tag 212 to determine the detected characteristics. In some embodiments, the shelf 200 can include a sensing engine 214 in wired and/or wireless communication with the shelf 200. The sensing engine 214 can receive detected characteristics from the plurality of sensors 206 disposed within the housing. As an example, based on a change in weight or pressure detected by the sensors 206, the sensing engine 214 can determine the time and day of delivery of the merchandise to the housing. The sensing engine 214 can further transmit an alert to the customer indicating that delivery of merchandise has been made and providing the identity of the merchandise. The customer can thereby be informed of the exact merchandise being delivered.

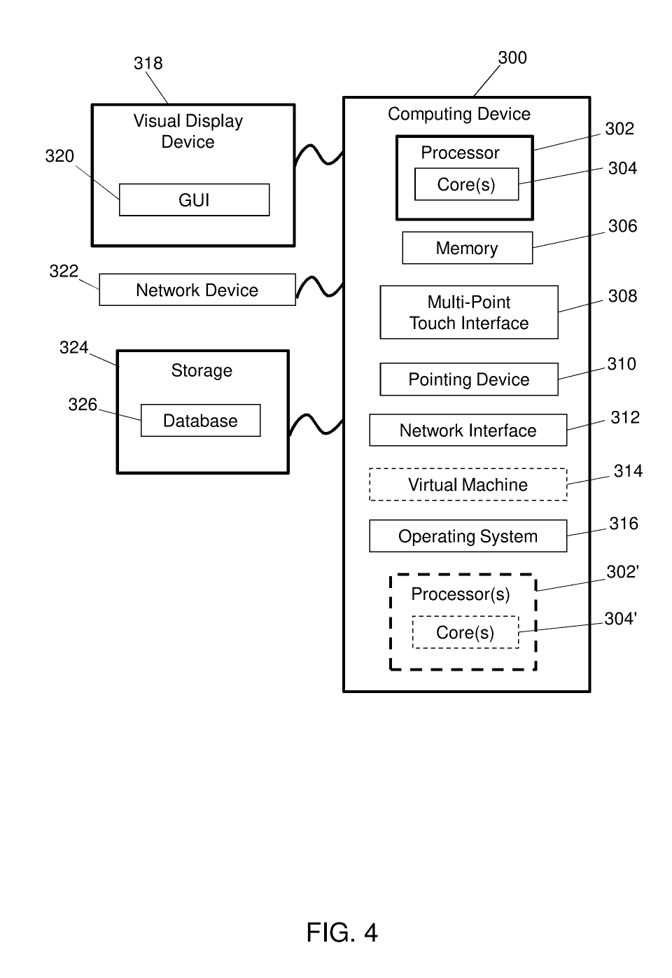

FIG. 4 is a block diagram of a computing device 300 in accordance with exemplary embodiments of the present disclosure. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 306 included in the computing device 300 may store computer-readable and computer-executable instructions or software for implementing exemplary embodiments of the present disclosure (e.g., instructions for actuating the sensors 110, instructions for operating the communication interface 104, instructions for operating the central computing system 106, combinations thereof, or the like). The computing device 300 also includes configurable and/or programmable processor 302 and associated core 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device 300 may be shared dynamically. A virtual machine 314 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 318 (e.g., a personal computer, a mobile smart device, or the like), such as a computer monitor, which may display one or more user interfaces 320 (e.g., GUI 116) that may be provided in accordance with exemplary embodiments. The computing device 300 may include other I/O devices for receiving input from a user, for example, a keyboard or any suitable multi-point touch interface 308, a pointing device 310 (e.g., a mouse). The keyboard 308 and the pointing device 310 may be coupled to the visual display device 318. The computing device 300 may include other suitable conventional I/O peripherals.

The computing device 300 may also include one or more storage devices 324, such as a hard-drive, CD-ROM, or other computer readable media, for storing data and computer-readable instructions and/or software that implement exemplary embodiments of the system 100 described herein. Exemplary storage device 324 may also store one or more databases 326 for storing any suitable information required to implement exemplary embodiments. For example, exemplary storage device 324 can store one or more databases 326 for storing information, such as data relating to sensor information 120, merchandise information 122, combinations thereof, or the like, and computer-readable instructions and/or software that implement exemplary embodiments described herein. The databases 326 may be updated by manually or automatically at any suitable time to add, delete, and/or update one or more items in the databases.

The computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 300 may run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 316 may be run in native mode or emulated mode. In an exemplary embodiment, the operating system 316 may be run on one or more cloud machine instances.

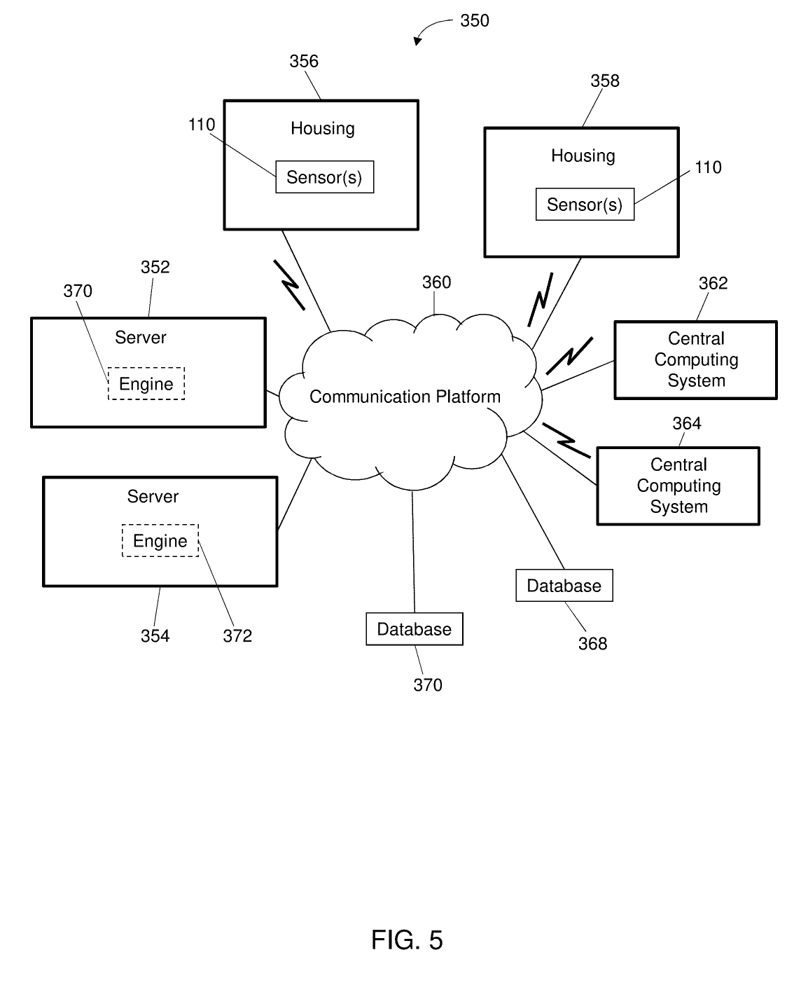

FIG. 5 is a block diagram of an exemplary merchandise enclosure system environment 350 in accordance with exemplary embodiments of the present disclosure. The environment 350 can include servers 352, 354 configured to be in communication with housings 356, 358 (including sensors 110), via a communication platform 360, which can be any network over which information can be transmitted between devices communicatively coupled to the network. For example, the communication platform 360 can be the Internet, Intranet, virtual private network (VPN), wide area network (WAN), local area network (LAN), and the like. In some embodiments, the communication platform 360 can be part of a cloud environment. The environment 350 can include central computing systems 362, 364, which can be in communication with the servers 352, 354, as well as the housings 356, 358, via the communication platform 360. The environment 350 can include repositories or databases 366, 368, which can be in communication with the servers 352, 354, as well as the housings 356, 358 and the central computing systems 362, 364, via the communications platform 360.

In exemplary embodiments, the servers 352, 354, housings 356, 358, central computing systems 362, 364, and databases 366, 368 can be implemented as computing devices (e.g., computing device 300). Those skilled in the art will recognize that the databases 366, 368 can be incorporated into one or more of the servers 352, 354 such that one or more of the servers 352, 354 can include databases 366, 368. In some embodiments, the database 366 can store the sensor information 120, and the database 368 can store the merchandise information 122. In some embodiments, a single database 366, 368 can store both the sensor information 120 and the merchandise information 122. In some embodiments, embodiments of the servers 352, 354 can include one or more engines 370, 372. In some embodiments, the central computing systems 362, 364 can interface with the servers 352, 354 to execute instances of the engines 370, 372 to perform one or more processes described herein including, e.g., identifying and/or verifying the physical objects deposited in the enclosures.

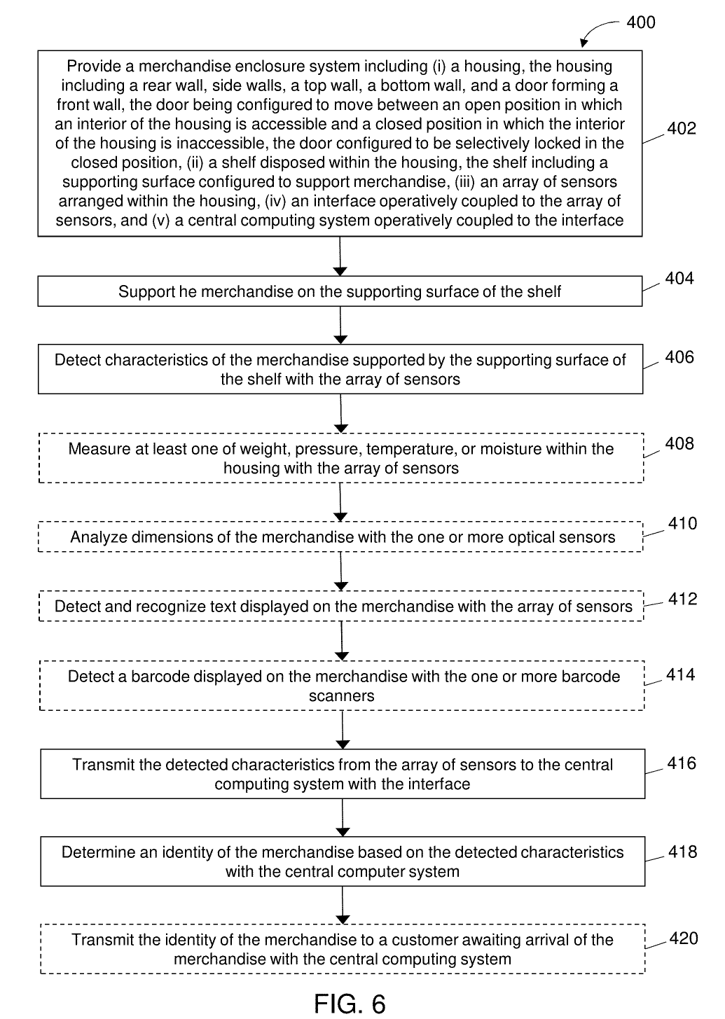

FIG. 6 is a flowchart illustrating an exemplary process 400 as implemented by embodiments of the merchandise enclosure system 100. To begin, at step 402, the merchandise enclosure system 100 is provided. At step 404, the merchandise can be supported on the supporting surface of the shelf. At step 406, characteristics of the merchandise supported by the supporting surface of the shelf (and/or characteristics of the housing) can be detected with the array of sensors. In some embodiments, at step 408, at least one of the weight, pressure, temperature, or moisture within the housing can be measured with the array of sensors.

In embodiments including optical sensors, at step 410, the dimensions of the merchandise can be analyzed with the one or more optical sensors. In some embodiments, at step 412, text displayed on the merchandise can be detected and recognized with the array of sensors. In embodiments including barcode scanners, at step 414, the barcode displayed on the merchandise can be detected with the one or more barcode scanners. At step 416, the detected characteristics can be transmitted from the array of sensors to the central computing system with the interface. At step 418, an identity of the merchandise can be determined with the central computing system based on the detected characteristics. At step 420, the identity of the merchandise can be transmitted with the central computing system to a customer awaiting arrival of the merchandise.

Thus, the exemplary merchandise enclosure system provides the customer real-time (or substantially real-time) information regarding the identity of merchandise delivered to the enclosure. In particular, rather than only receiving the time of delivery of merchandise, the customer is provided with the exact identity of the merchandise. Providing such information to the customer allows the customer to be better informed in making decisions regarding the delivered merchandise, such as whether the delivered merchandise should be retrieved in a timely manner (e.g., for time-sensitive items).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An enclosure system, comprising:
a housing, the housing including a rear wall, side walls, a top wall, a bottom wall, and a door forming a front wall, the door being configured to move between an open position in which an interior of the housing is accessible and a closed position in which the interior of the housing is inaccessible, the door configured to be selectively locked in the closed position;
a shelf disposed within the housing, the shelf including a supporting surface configured to support physical object;
an array of sensors arranged within the housing and configured to detect characteristics of the physical object supported by the supporting surface of the shelf; and
an interface operatively coupled to the array of sensors and configured to transmit the detected characteristics from the array of sensors to a central computing system, the central computing system being configured to determine an identity of the physical object based on the detected characteristics.

2. The enclosure system of claim 1, wherein the array of sensors are arranged on at least one of the side walls, the top wall, the bottom wall, or an inner surface of the door of the housing.

3. The enclosure system of claim 1, wherein the array of sensors is configured to measure at least one of weight, pressure, temperature, or moisture within the housing.

4. The enclosure system of claim 1, wherein the array of sensors includes one or more optical sensors configured to analyze dimensions of the physical object.

5. The enclosure system of claim 1, wherein the array of sensors is configured to detect and recognize text displayed on the physical object.

6. The enclosure system of claim 1, wherein the array of sensors includes a piezoelectric grid, each component of the piezoelectric grid being configured to detect characteristics of the physical object.

7. The enclosure system of claim 1, wherein the array of sensors includes one or more barcode scanners configured to detect a barcode displayed on the physical object.

8. The enclosure system of claim 1, wherein the array of sensors defines a three dimensional array of sensors arranged within the housing.

9. The enclosure system of claim 1, wherein the central computing system is configured to transmit the identity of the physical object to a customer awaiting arrival of the physical object.

10. A method of monitoring an interior of a secure enclosure, comprising:
providing an enclosure system including (i) a housing, the housing including a rear wall, side walls, a top wall, a bottom wall, and a door forming a front wall, the door being configured to move between an open position in which an interior of the housing is accessible and a closed position in which the interior of the housing is inaccessible, the door configured to be selectively locked in the closed position, (ii) a shelf disposed within the housing, the shelf including a supporting surface configured to support a physical object, (iii) an array of sensors arranged within the housing, (iv) an interface operatively coupled to the array of sensors, and (v) a central computing system operatively coupled to the interface;
supporting the physical object on the supporting surface of the shelf;
detecting characteristics of the physical object supported by the supporting surface of the shelf with the array of sensors;
transmitting the detected characteristics from the array of sensors to the central computing system with the interface; and
determining an identity of the physical object based on the detected characteristics with the central computer system.

11. The method of claim 10, wherein the array of sensors are arranged on at least the side walls, the top wall, the bottom wall, or an inner surface of the door of the housing.

12. The method of claim 10, comprising measuring at least one of weight, pressure, temperature, or moisture within the housing with the array of sensors.

13. The method of claim 10, wherein the array of sensors includes one or more optical sensors.

14. The method of claim 13, comprising analyzing dimensions of the physical object with the one or more optical sensors.

15. The method of claim 10, comprising detecting and recognizing text displayed on the physical object with the array of sensors.

16. The method of claim 10, wherein the array of sensors includes a piezoelectric grid, each component of the piezoelectric grid being configured to detect characteristics of the physical object.

17. The method of claim 10, wherein the array of sensors includes one or more barcode scanners.

18. The method of claim 17, comprising detecting a barcode displayed on the physical object with the one or more barcode scanners.

19. The method of claim 10, comprising transmitting the identity of the physical object to a customer awaiting arrival of the physical object with the central computing system.

20. A non-transitory computer-readable medium storing instructions for monitoring a physical object positioned on a shelf of a secure enclosure that are executable by a processing device, the secure enclosure including a housing, the housing including a rear wall, side walls, a top wall, a bottom wall, and a door forming a front wall, the door being configured to move between an open position in which an interior of the housing is accessible and a closed position in which the interior of the housing is inaccessible, the door configured to be selectively locked in the closed position, a shelf disposed within the housing, the shelf including a supporting surface configured to support the physical object, an array of sensors arranged within the housing, and an interface operatively coupled to the array of sensors, wherein execution of the instructions by the processing device causes the processing device to:
detect characteristics of the physical object supported by the supporting surface of the shelf with the array of sensors;
transmit the detected characteristics from the array of sensors to a central computing system with an interface; and
determine an identity of the physical object based on the detected characteristics with the central computing system.
